(19) United States
(12) Patent Application Publication
(10) Pub. No.: US 2013/0290098 A1
(43) Pub. Date: Oct. 31, 2013

(54) SYSTEM AND METHOD FOR BRAND AFFINITY CONTENT DISTRIBUTION AND PLACEMENT

(71) Applicants: Ryan Steelberg, Irvine, CA (US); Chad Steelberg, Newport Beach, CA (US)

(72) Inventors: Ryan Steelberg, Irvine, CA (US); Chad Steelberg, Newport Beach, CA (US)

(73) Assignee: Brand Affinity Technologies, Inc., Irvine, CA (US)

(21) Appl. No.: 13/915,011

(22) Filed: Jun. 11, 2013

Related U.S. Application Data
(63) Continuation of application No. 12/586,963, filed on Sep. 30, 2009.
(60) Provisional application No. 61/101,351, filed on Sep. 30, 2008.

(51) Int. Cl. G06Q 30/02

(52) U.S. Cl. CPC G06Q 30/0251
USPC 705/14.49

(57) ABSTRACT

An apparatus, system and method for placing an advertisement is disclosed. An audio work may be analyzed for at least one keyword. The at least one keyword may be accessed for its relevance to an advertisement. Based on the assessment of the at least one keyword and an avail of the audio work, the advertisement may be placed within the audio work.

### CROSS REFERENCE TO RELATED APPLICATIONS

The present application is a continuation application of U.S. application Ser. No. 12/586,963, filed Sep. 30, 2009, which claims priority to U.S. Provisional Application No. 61/101,351 entitled “System and Method For Brand Affinity Content Distribution and Placement,” filed Sep. 30, 2008, the entire disclosures of which are incorporated by reference herein as if set forth in their entireties.

### FIELD OF THE INVENTION

The present invention is directed to an advertising engine and, more particularly, to an engine for generation of brand affinity content, and a method of making and using same.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention includes at least an endorsed advertising engine, system and method, which includes at least one vault having media assets, a recommendation engine that matches the media assets from the vault with at least one requested creative, and a delivery engine that integrates the requested creative with the matched media assets from the vault.

In an embodiment of the present disclosure, an apparatus, system and method for placing an advertisement is disclosed. An audio work may be analyzed for at least one keyword. The at least one keyword may be accessed for its relevance to an advertisement. Based on the assessment of the at least one keyword and an avail of the audio work, the advertisement may be placed within the audio work.

Thus, the present invention provides an engine, system and method that allows for the obtaining of an endorsement or sponsorship, in the aforementioned high-impact circumstances, either from a specific individual, a specific entity, an affinity brand, a marketing partner, or a sponsor.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an exemplary embodiment of the present invention;

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical collagen shields, corneal interfaces and in laser eye surgeries. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

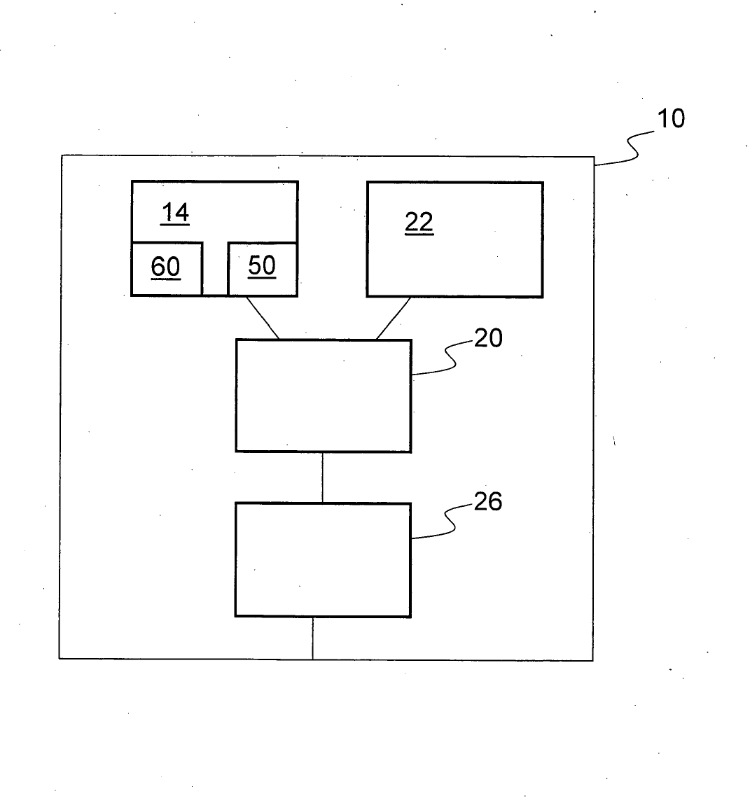

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Needless to say, the aforementioned engines may be included in the present invention in any combination of one or more engines. Ad requests 22 may be made via an “ad wizard” using ad templates, as will be apparent to those skilled in the art.

The vault captures certain brands and information related thereto, such as use rules, in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. As used herein, and as recognized by one skilled in the art in light of this disclosure, media is defined to be anything that a user can perceive, including but not limited to audio, video, photograph and text data. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and may place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and daypart information. Gathered data intelligence may be used as individual properties in conjunction with each other to form or produce the level of intelligence needed to achieve the desired efficiencies. By way of further example, data intelligence may also include information regarding the number of impressions an ad has received, and/or the elapsed time between an impression or a click. Additionally, data intelligence may include information regarding valuable ads or creatives that should have been, but were not, placed, such as, for example, available ad slots online, on television, on radio, or the like, into which a competitor or competitive product or service, was placed. Thereby, data intelligence provides for a reevaluation of value, thus enabling an advertiser to not miss optimal opportunities more than once.

Thus, utilizing data intelligence allows the delivery engine 26 to optimize targeting to new and the equivalent of past targets. Optimization may include efficiencies of time and control over redundancies and ad targeting, for example. Optimization allows for the prediction of probable impressions or clicks that a certain ad or creative may receive when, for example, or that similar past ads have received, for example, with consideration of certain factors, such as demographic and geographic, for example. A prediction may also be made regarding the efficiency of paid searches, and/or may be further contrasted with, for example, display ads. Such information, as drawn from the data intelligence, may also allow for the higher success rates related to redundant ad placement based on prior behavior of a particular audience, for example. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity. For example, date intelligence may monitor the number of “avails” of prime time tv characters wearing sports jerseys, and based on Neilsen ratings, the exposures gained by those advertisers placing to such avails. Thus, data intelligence may suggest an optimal value of placing to such avails for a sports jersey seller for future ones of such avails.

The delivery engine 26 may also choose to deactivate and/or modify certain creatives based on data intelligence and/or user direction. The delivery engine may include fulfillment offline, such as on tv, for example. By way of non-limiting example, the data intelligence may be collected from several ad or creative types over any number of varying media formats, allowing for even more sophisticated optimization, and ultimately delivery, based on the allocation of impressions and clicks in the various media formats. Media formats may include, but are not limited to, internet, t.v., radio, mobile devices, kiosks, billboards, product placements, and print. By further way of non-limiting example, data intelligence gathered during a run of a creative on the radio may effect the play of an ad on the internet, for example. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through and/or viewership/listenership. Such optimization may thus be done in real time and over multiple media types. The optimization may, by way of further non-limiting example, call for the addition of ads or creatives not currently within the campaign(s), thus suggesting what type of ads or creatives are required for optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted avails, thus maximizing the value of the eventual placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

Further, the present invention may facilitate the placement of assets, creatives, and/or products in a variety of display mediums. More specifically, in an embodiment of the present invention, the delivery engine 26 may facilitate the placement of brands in various media through the aforementioned marketplace of avails offered for sale. This marketplace brings together both advertisers and media owners allowing for the matching of products with appropriate placements offered for sale by media owners within the created media. Created media may include TV, film, music, advertising, video games, software products, on-line content, and events, for example.

Product placements, as they are generally referred to in the industry, are “avails” as discussed herein and foster brand recall, feeling and purchase intent. Placements may include visual avails, including prop usage and background placements, in created media as well as in dialogue mentions. The present invention joins together media owners, studios, production companies, and “below-the-line” production staff (collectively “media owners”) with marketers, product placement agencies and advertising agencies (collectively “placement owners”). The ability of media owners and placement owners to participate in a real-time marketplace where assets may be bought and sold may provide a more efficient exchange of assets as well as providing a better opportunity to exploit assets of lesser value by reducing transaction costs.

In an embodiment of the present invention, the placements offered for sale may themselves be considered assets within the present invention. Working in conjunction with the brand association and recommendation engine 20, the present invention may connect, for example, a product with a placement, and may ultimately deliver through the delivery engine 26, for example. For example, the owner of placements in a television show may offer for sale at least one placement in a designated show at a particular point during the show. A value may be assigned to the placement based on the type of placement offered and the number of views the placement is expected to have, for example. A buyer or media owner may review the parameters of the placement and purchase the placement for use with a particular asset. If the placement is not well understood through textual explanation or visual cues, the placement, with or without usage of the asset, may be reviewed by the media owner before final acceptance of the placement occurs.

Furthermore, the present invention may track the various metrics surrounding the placement before and after placement. Such metrics may allow for a more refined valuing of the placement offered and may allow for a variety of payment options between the media and placement owners, for example. The metrics tracked for this purpose may be viewership ratings, demographic response, syndication rights, content and/or genre of the media, and delivery method on which the media is based or is likely to be viewed or heard, for example. Such an array of metrics not only allows for a refined estimation of value for the original placement offer, but may also facilitate the offering of deferred payment structured placements. For example, a placement owner my collect a fee from a media owner and may collect a continuous fee based on the repeating play nature of re-runs and/or syndication, for example.

The metrics gathered may also produce a “ratings score” which may be used by the media holder to value and plan potential placements across a spectrum of available and non-available placements. The ratings score thus takes into account a comparison of placements available through the provided marketplace with those otherwise made available through traditional outlets. This outward view to the total of available placements in the industry at large provides users of the system with a more refined and objective understanding of the value and coverage of the placements being made, thus increasing the confidence users of the marketplace have in the valuations made by the system.

Furthermore, the recommendation engine 20 may provide the user with suggested placements or media which may be optimal in terms of maximizing the value and coverage of each product placement. The recommendations made may be approved or denied by a user, and may be modified in that more than one placement option may be suggested. For example, the recommendation engine 20 may recommend a “fall” schedule of placements that would account for previous placements and budgets applied by the media owner, and the availability and prior consents by the placement owner. The recommendation engine 20 may also query each party to understand current needs and constraints in order to suggest a placement schedule in-line with known parameters. As would be expected, any direct input by users of the system may be used by the recommendation engine 20 to suggest various placements at any point during a given period. For example, if there is a discounted placement that would fit a particular product, the media owner may be alerted to the favorable placement.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A method for placing an advertisement, the method comprising:
analyzing an audio work for at least one keyword in the audio work, assessing a relation between the at least one keyword and an advertisement;
based on the assessing of the relation, and based on a presence of an avail in the audio work, placing the advertisement within the audio work.

2. The method of claim 1, wherein the audio work comprises video.

3. The method of claim 1, wherein the analyzing comprises using dialogue recognition software.

4. The method of claim 1, wherein the keyword is analyzed from human readable text.

5. The method of claim 1, wherein the audio work comprises at least one photograph.

6. The method of claim 1, wherein the audio work comprises a radio work.

7. The method of claim 1, wherein the avail is present within a particular time from the keyword.

8. The method of claim 1, wherein the avail is present before a particular audience.
